(19) United States
(12) Patent Application Publication
(10) Pub. No.: US 2004/0094631 A1
(43) Pub. Date: May 20, 2004

(54) Steam turbine identification number

(76) Inventors: Sean Douglas Feeny, Ballston Spa, NY (US); Victor Robert Abate, Waterford, NY (US); Thomas Edward Ostrander, Saratoga Springs, NY (US); Anthony John Lucci, Clifton Park, NY (US); Robert Blair Wilson, Ballston Lake, NY (US)

Correspondence Address: NIXON & VANDERHYE P.C., 8th Floor, 1100 North Glebe Rd., Arlington, VA, 22201-4714, US

(21) Appl. No.: 10/298,010

(22) Filed: Nov. 18, 2002

(51) Int. Cl. G06K 19/06

(52) U.S. Cl. 235/494

(57) ABSTRACT

A method of identifying a steam turbine includes defining a plurality of individual blocks that identify critical design features for a plurality of turbine sections, and separating each of the individual blocks with separators. Exemplary blocks are defined for, for example, turbine code type, rotational speed, maximum capability of structured design, nominal design conditions, high-pressure, intermediate-pressure and low-pressure block levels, high-pressure design type, low-pressure last stage bucket, and generator type. The identification number contains the minimum required set of criteria to identify a unique, structured turbine design. The number can be used to identify duplication as well as cost and design attributes that are significant for consistency across a power generation business.

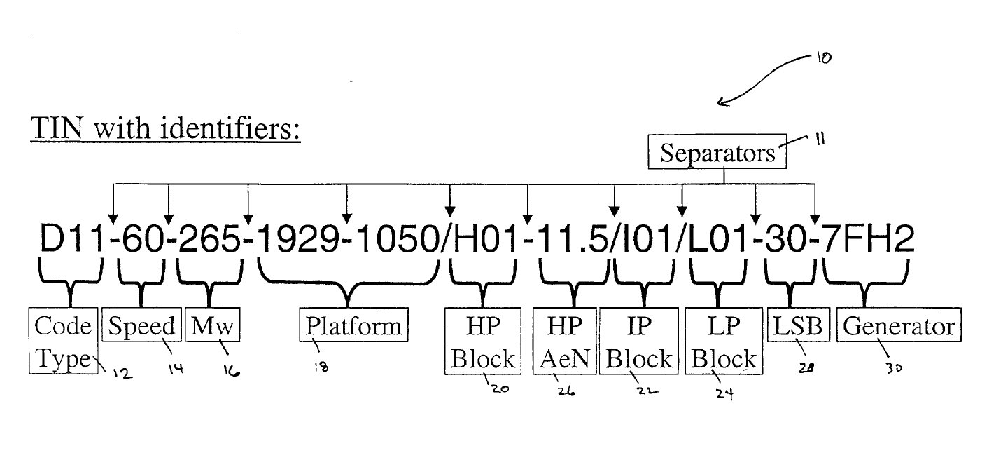

### BACKGROUND OF THE INVENTION

The present invention relates generally to steam turbines and, more particularly, to a method implementing a steam turbine identification number for identifying a steam turbine.

Steam turbines have traditionally only been identified based on code type, which offers only generic information about a steam turbine configuration. Other critical information such as number of stages, bucket type and size, and diaphragm type and size are not specified. This level of detail is helpful to establish cost and cycle in the proposal and execution phases as well as identifying duplication from a unit to unit basis. In addition, when a customer requests an upgrade on old units, it is difficult to understand the design features without reviewing all the drawings. In order to fulfill these requirements, a new, improved naming convention is required with sufficient detail that can be easily used for a given steam turbine design. This naming convention would provide information to quickly reference all critical design information.

Conventionally identified code type only provides detail on the steam turbine configuration (i.e., type of sections, single flow or double flow) . Details that drove cost and cycle had to be determined from correspondence and other data that was cumbersome and provided opportunities for errors.

### BRIEF DESCRIPTION OF THE INVENTION

In an exemplary embodiment of the invention, a method of identifying a steam turbine includes defining a plurality of individual blocks that identify critical design features for a plurality of turbine sections, and separating each of the individual blocks with separators.

In another exemplary embodiment, the method includes defining a plurality of individual blocks that identify critical design features for a plurality of turbine sections, wherein the individual blocks are defined for at least three of turbine code type, rotational speed, maximum capability of structured design, nominal design conditions, high-pressure, intermediate-pressure and low-pressure block levels, high-pressure design type, low-pressure last stage bucket, and generator type.

In still another exemplary embodiment, a method of identifying a steam turbine includes defining a plurality of individual blocks that contain a minimum required set of criteria to identify a unique structured steam turbine design, and enabling identification of duplication and critical cost and design attributes.

### BRIEF DESCRIPTION OF THE DRAWINGS

The FIGURE illustrates an exemplary steam turbine identification number of the present invention.

### DETAILED DESCRIPTION OF THE INVENTION

With reference to the FIGURE, the steam turbine identification number 10 in its application to structured steam turbine designs summarizes all of the critical design features for the various turbine sections into “blocks” such that these design features cannot be changed for a given block. Blocks are arranged by section such that “block changes” can be made on a section basis rather than a unit basis. This steam turbine identification number 10 can be referenced by all areas of the business and allows for a simple and consistent communication of all design information.

A structured steam turbine design is based on a customer design envelope in which optimization is performed to establish standardized LP (low-pressure) section and IP (intermediate-pressure) section flow conditions. Since the LP section is a function of the customer's backpressure, this standardization is typically performed across a variety of LP last stage buckets (LSB). This then leaves the HP (high-pressure) section to vary across the range of possible flow conditions established by the customer. However, if this design range is broken up into a finite number of points, HP sections can be pre-designed in addition to the IP and LP sections. Once these designs are complete, each section design is frozen into a “block,” and individual design attributes cannot change except through a block change. These block levels will then coincide with specific design criteria that are used for cost, performance, cycle, upgrade, and other evaluations.

Block levels are used with other criteria in creation of the steam turbine identification number 10, which preferably includes at least three of the following information items separated by suitable separators 11:

code type 12;

rotation speed 14;

maximum capability of structured design or power rating 16;

nominal design conditions or turbine platform designation 18;

HP, IP, and LP block levels 20, 22, 24;

HP design type (based on customer conditions) or HP AeN 26;

LP LSB (driven by customer conditions) 28; and

Generator type 30.

With the method of identifying a steam turbine of the invention, by assembling information into one identification number that follows a turbine through its design cycle, administration of design maintenance parameters as well as customer service is facilitated.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of identifying a steam turbine, the method comprising defining a plurality of individual blocks that identify critical design features for a plurality of turbine sections, and separating each of the individual blocks with separators.

2. A method according to claim 1, wherein the defining step comprises defining individual blocks for turbine code type, rotational speed, maximum capability of structured design, nominal design conditions, high-pressure, intermediate-pressure and low-pressure block levels, high-pressure design type, low-pressure last stage bucket, and generator type.

3. A method of identifying a steam turbine, the method comprising defining a plurality of individual blocks that identify critical design features for a plurality of turbine sections, the individual blocks being defined for at least three of turbine code type, rotational speed, maximum capability of structured design, nominal design conditions, high-pressure, intermediate-pressure and low-pressure block levels, high-pressure design type, low-pressure last stage bucket, and generator type.

4. A method of identifying a steam turbine, the method comprising defining a plurality of individual blocks that contain a minimum required set of criteria to identify a unique structured steam turbine design, and enabling identification of duplication and critical cost and design attributes.
